(19) United States
(12) Patent Application Publication
(10) Pub. No.: US 2006/0031484 A1
(43) Pub. Date: Feb. 9, 2006

(54) Automated time keeping system and method

(76) Inventor: Kevin M. O'Neill, Overland Park, KS (US)

Correspondence Address: CHASE LAW FIRM L.C, 4400 COLLEGE BOULEVARD, SUITE 130, OVERLAND PARK, KS, 66211, US

(21) Appl. No.: 11/196,536

(22) Filed: Aug. 3, 2005

Related U.S. Application Data
(60) Provisional application No. 60/598,886, filed on Aug. 4, 2004.

(51) Int. Cl. G06F 15/173; G04F 10/00

(52) U.S. Cl. 709/224; 702/176

(57) ABSTRACT

A time keeping system includes a computer, which can be configured either standalone or in a network. The system is preprogrammed with a Maximum Inactivity Duration (MID) value. When the duration of inactivity at the computer exceeds MID, the user is automatically logged off. The MID can be subtracted from the activity duration value to derive an adjusted activity duration value. A time keeping method utilizes the system for automatically determining activity durations as a function of the difference between log in and log off times, from which the MID can be subtracted. An administrator can observe, save and report information relating to activity durations for all of the computer terminals in the system.

### CROSS-REFERENCE TO RELATED APPLICATION

This application claims the benefit of U.S. provisional application Ser. No. 60/598,886, which is incorporated herein by reference.

### BACKGROUND OF THE INVENTION

1. Field of the Invention

The present invention relates generally to computerized business recordkeeping functions, and in particular to an automated time clock system and method.

2. Description of the Related Art

Computer systems, including standalone and networked configurations, are widely used in business for various functions, including employee recordkeeping. For example, systems that allow individuals to log in to respective networked computers for indicating their presence at or absence from their places of employment are known. Businesses and other organizations also commonly use computer systems for a wide variety of bookkeeping-related applications, including payroll preparation and reporting.

Present timekeeping information management systems are susceptible to inaccuracies, which are often associated with users inputting misinformation or inadvertently omitting certain necessary procedures. For example, an employee forgetting to log off of his or her computer at work may appear to be present and accruing time for which he or she would be appear to be entitled to compensation. Although such mistakes can commonly be remedied, for example by correcting the time records after-the-fact, such corrections are susceptible to inaccuracies. Moreover, many computer system users are required to perform various job-related procedures in connection with their assigned computers. Such responsibilities can include various information and communication management tasks, file management, scheduling and other procedures, all of which can encroach on the productive time remaining for employees' primary job responsibilities. Additional computer-related procedures, such as timekeeping and recordkeeping functions requiring specific actions on the part of the users, can be regarded as inconvenient or burdensome, particularly among computer users who must devote substantial time to routine computer tasks such as e-mail communications, etc.

A time keeping software solution would preferably require minimal input from users by automating as many procedures as possible. Such a software solution would preferably be adaptable to various computer hardware and software systems, provide maximum convenience for computer users and facilitate accurate and reliable time keeping and payroll functions for organizations using same. Effective human resource management could be facilitated with such a time keeping software solution. For example, tasks could be better distributed on the basis of human resource availability. Moreover, more appropriate levels of responsibility and assistance could be delegated to the employees and associates of organizations. Greater potential work-related accomplishments and results could thereby be realized by the organizations and individuals.

Heretofore there has not been available a system and method for automating conventional time clock payroll recordkeeping functions with the advantages and features of the present invention.

### SUMMARY OF THE INVENTION

In the practice of the present invention, a system and method are provided for automatically initiating a time keeping function, which can be associated with a standalone or networked computer system. The time keeping system can automatically log off users after predetermined, administrator-set periods of terminal inactivity designated Maximum Inactivity Duration (MID). The system administrator can access the records in an entire system corresponding to an organization for purposes of managing human resources and facilitating payroll operations.

### BRIEF DESCRIPTION OF THE DRAWINGS

FIG. 1 is a block diagram of a networked computer system in an organization, to which the time keeping system of the present invention can be applied.

FIG. 2 is a flowchart of an aspect of the method of the present invention, particularly showing the general steps involved in performing the time keeping method.

FIG. 3 is a flowchart showing an aspect of the method of the present invention, including the user interface steps associated with performing the method.

FIG. 4 is a view of a computer monitor showing the Graphic User Interface (GUI) including a screensaver with a log in window adapted for initiating the time keeping function.

FIG. 5 is a view of a computer monitor showing the GUI including a log off window.

FIG. 6 is a view of a central display, such as might be monitored by a computer system administrator.

FIG. 7 is a view of an individual terminal display, such as might be available to its user.

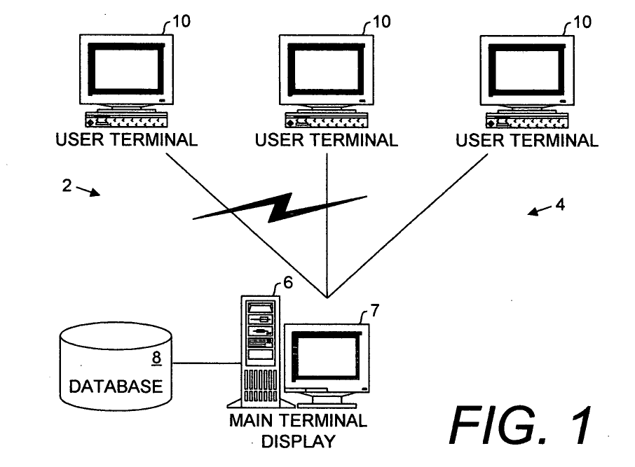

### DETAILED DESCRIPTION OF THE PREFERRED EMBODIMENTS

I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. Said terminology will include the words specifically mentioned, derivatives thereof and words of similar meaning.

Referring to the drawings in more detail, the reference numeral 2 generally designates a computer system configured as a network 4 including a server 6, which can be connected to or include a database 8 and multiple terminals 10 with monitors 11. The present invention is also adapted for application to standalone computers and various network configurations including LANs, WANs, etc. The hardware and software components of the network 4 are also virtually unlimited, and can be configured, designed and constructed pursuant to the criteria and functions of various applications, which can benefit from the time keeping system present invention. Moreover, the time keeping system can be utilized in connection with networks of networks, which can be linked via the Worldwide Web (Internet). Still further, the system 2 can accommodate “telecommuters”, who work remotely and login to the network 4 from various remote locations, including their homes, travel destinations, while in transit, etc.

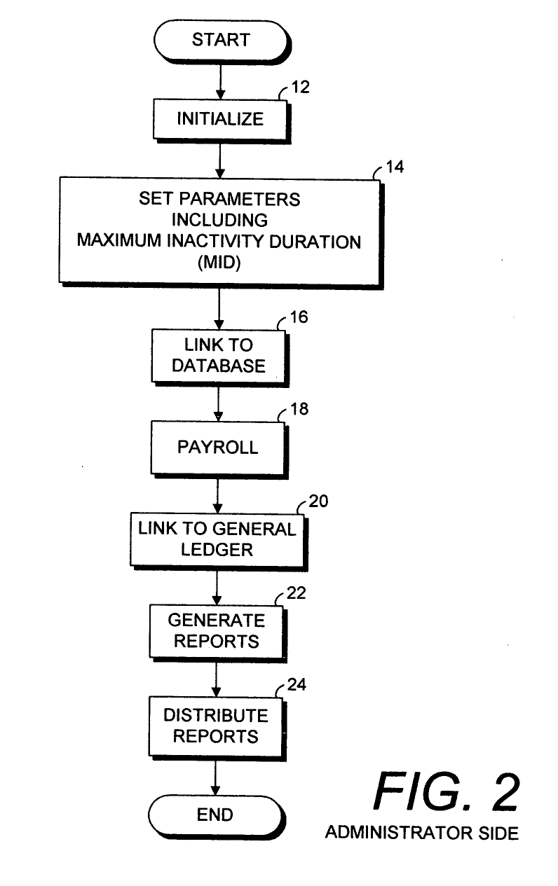

In the practice of the method of the present invention, as shown from the administrative side in FIG. 2, the system is initialized at 12, e.g. by an administrator of the network 4. The operating parameters are set at 14 and can include user names, passwords and operating variables and functions. For example, the administrator can set the Maximum Inactivity Duration (MID) variable, which is described in more detail below. Also as shown in FIG. 2, the time keeping system links to the database 8 for storing and retrieving information at step 16. At step 18 time keeping system links to a payroll function, which can be implemented by appropriate software. The payroll function links to suitable general ledger or other appropriate recordkeeping, reporting or general business software at 20. Reports relating to the time keeping and payroll functions can be generated at step 22. Such reports can be provided to employees, personnel files, governmental agencies (e.g. taxation and revenue departments), payroll services, etc. at step 24.

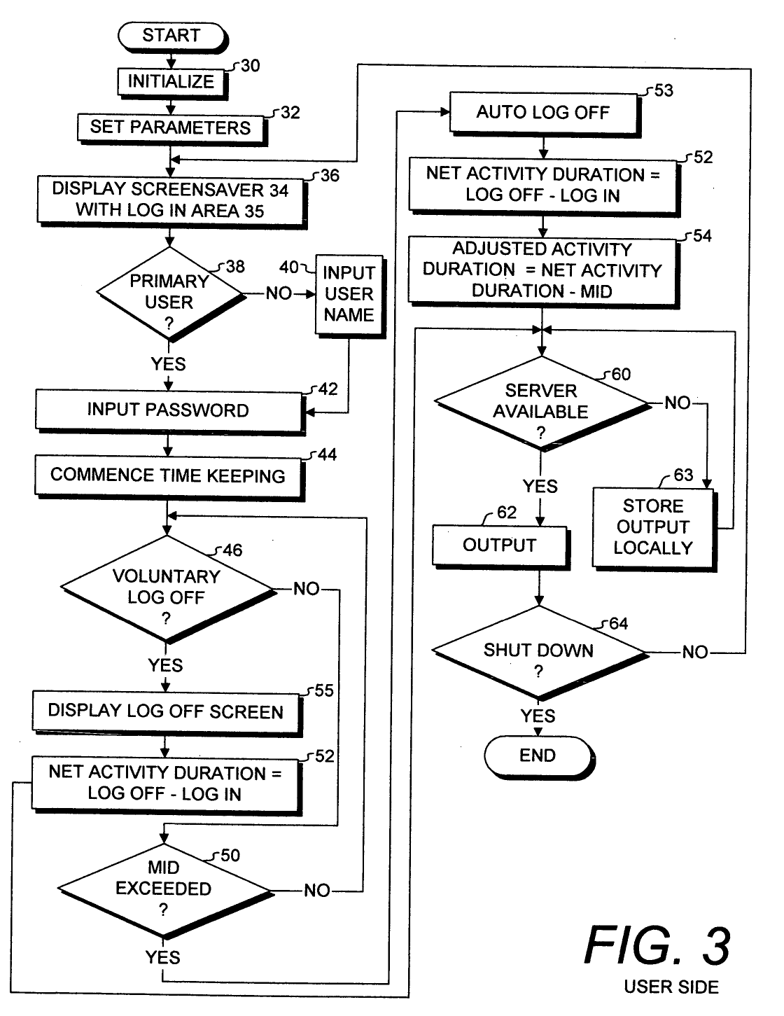

FIG. 3 shows the user side of the method of the present invention. A user can comprise a person, an entity or another computer system. The user initializes the system at 30, e.g. by setting his or her user name, password and other user-controlled variables. The MID variable can optionally be set by the user at 32 if permitted, otherwise this variable can be reprogrammed with the software implementing the time keeping system 2 or can be set by the administrator. For example, an entity with multiple employees utilizing the time keeping system 2 might establish a standard MID for all employees as a matter of company policy. Alternatively, the MID can be user-adjustable, and can be preprogrammed with multiple values corresponding to the MIDs appropriate for various tasks and applications, including multi-tasking operations.

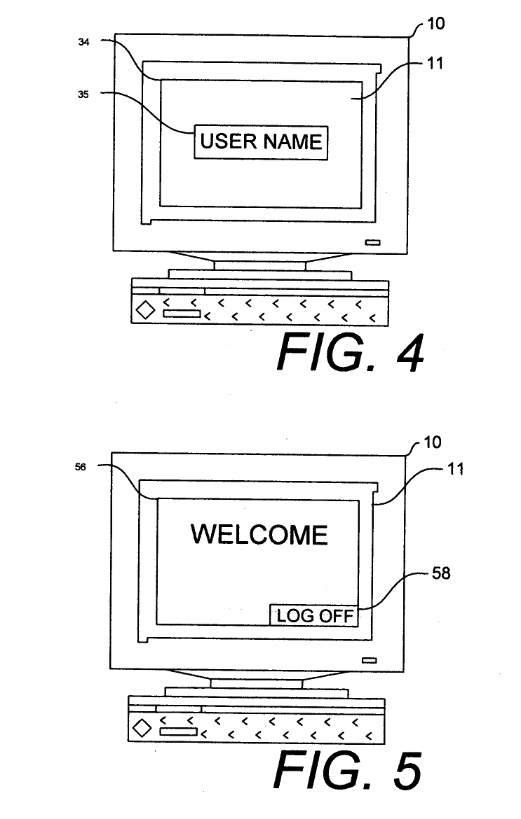

A screensaver 34 with a log in area 35 (FIG. 4) is displayed at 36 and the method proceeds to a primary user decision box 38, from which a negative decision leads to a user name input at 40. The user name input step can optionally be skipped if the user is the primary user of the terminal, i.e. affirmative decision at 38. For example, the computer terminal 10 can be preprogrammed to default to a predetermined (i.e. primary) user name. An optional password is input at step 42, but can be omitted if deemed unnecessary. The log in procedure described above can be modified or adapted as appropriate. For example, biometrics, fingerprint recognition and other user-identifying/authenticating procedures and functions can be utilized with the method of the present invention. The screensaver 34 can remain displayed and pre-log in inputs such as keystrokes, mouse movements, etc. can be ignored until the user logs in.

After completing the log in procedure, the screensaver 34 disappears upon input to the computer 10 by a keystroke, mouse movement, etc. and the time keeping function commences at 44 by establishing a start time and starting a timer, whereafter the computer 10 functions normally. The timekeeping function continues to operate normally until a predetermined time keeping suspension function occurs. For example, a step in which the user voluntarily logs off at 46 establishes a stop time. A log off screen 56 including a log off area 58 (FIG. 5) is displayed at step 55. Another suspension function might involve the user opening an application or commencing an activity for which time would be suspended, which can be handled like a voluntary log off at step 46. For example, if the user interrupted his or her work on tasks for which time was being recorded by, for example, opening other software applications, the timekeeping function can be suspended at 46.

The MID variable provides an automatic suspension of the time recording function when the inactivity duration exceeds same, i.e. a positive result at decision box 50. For example, if the user were to leave work or otherwise discontinue activity on the computer 10 without logging off, the timekeeping system would automatically log him or her off after the MID elapsed. After the user is logged off, the net activity duration value is calculated at 52. If the log off resulted from the MID being exceeded, the MID time is subtracted from the net duration to provide an adjusted activity duration at 54. Thus, the user can be provided with an incentive to log off when he or she is finished with activity on the terminal 10 in order to avoid having the MID subtracted from the activity duration. The log off screen 56 (FIG. 4) is displayed for use in connection with a user-initiated (voluntary) log off procedure. Upon involuntary log off, e.g. by exceeding the MID, the screensaver 34 is displayed along with the log in area 35 whereby the user can restart the time keeping function.

If the server 6 is available (positive result at decision box 60), the method proceeds to an output activity duration step at 62 whereat the activity duration value can be F transferred to the server 6 for storage in the database 8 or for use in connection with any of the other functions described above. In the event the server 6 is unavailable (negative result at decision box 60), e.g. due to the network 4 being down or for some other reason, the activity duration information can be stored locally at step 63 for retrieval and output later. The output can be utilized to update the users' files, generate reports, calculate payroll, etc. An affirmative decision at the shut down decision box 64 ends the procedure. A negative decision at 64 leads to a display of the screensaver at step 36. Optionally, the screensaver display step 36 can be omitted and the system 4 can continue with another application. The time keeping system 2 can thus be used for tracking time in connection with various tasks, applications, customers, clients, activities, etc.

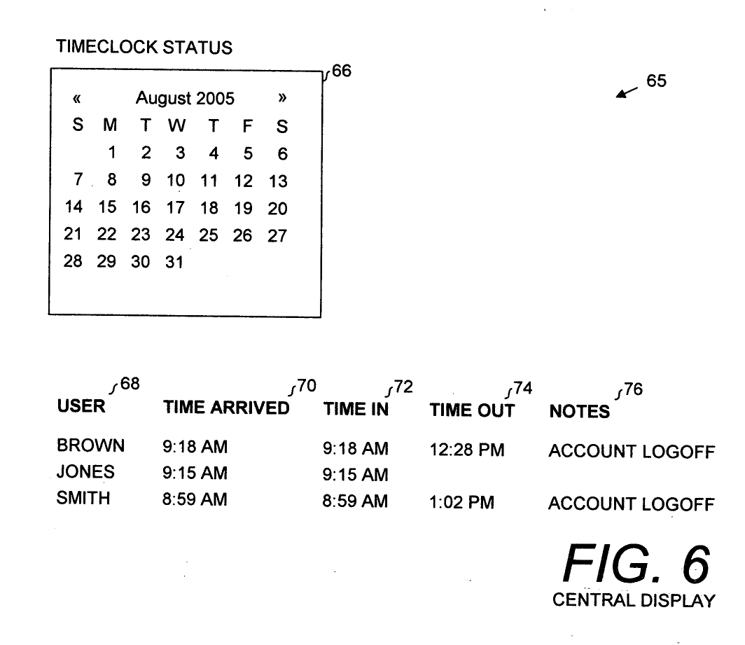

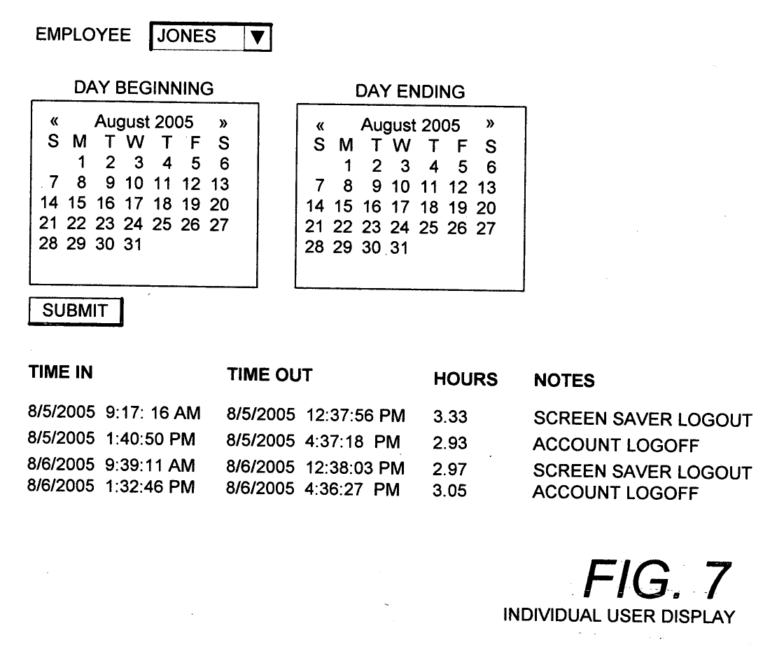

FIG. 6 shows a central or administrator display 65 of the type that would be available to an administrator for monitoring user activity. The display 65 can include a calendar 66 for convenient reference. Columns for User Name 68, Time Arrived 70, Time In 72, Time Out 74 and Notes 76 can be included in the display 65, along with other pertinent information. FIG. 7 shows an individual user display, which can correspond to his or her time records produced by the system and method of the present invention.

It is to be understood that the invention can be embodied in various forms, and is not to be limited to the examples discussed above. Other components and configurations can be utilized in the practice of the present invention.

Having thus described the invention, what is claimed as new and desired to be secured by Letters Patent is:

1. An automated time keeping method, which comprises the steps of:
providing a computer;
identifying a user of the computer;
logging in the user;
commencing an activity with a duration;
setting a start time for said activity duration;
preprogramming said computer with a predetermined maximum inactivity duration (MID);
monitoring said computer usage for inactivity in excess of said MID;
automatically logging the user off in response to inactivity in excess of said MID;
recording a user log off time;
calculating an adjusted activity duration corresponding to the elapsed time from said start time to the log off time minus said MID; and
recording said adjusted activity duration.

2. The method according to claim 1, which includes the additional steps of:
linking multiple said computers in a network;
providing an administrator or a server for said network; and
transmitting said adjusted activity duration information from said computers to said administrator or server.

3. The method according to claim 2, which includes the additional steps of:
providing said network administrator or server with a terminal including a monitor; and
displaying information corresponding to said activity durations associated with said computers on said administrator or server terminal monitor.

4. The method according to claim 3, which includes the additional steps of:
calculating work periods from said activity durations; and
generating payroll reports from said work period information.

5. The method according to claim 1, which includes the additional steps of:
providing a user log off procedure;
logging off a user in response to a user log off input command; and
calculating an activity duration corresponding to the time duration from said user log in to said user log off.

6. The method according to claim 5, which includes the additional steps of:
providing a database connected to said network;
inputting to said database information corresponding to said activity durations; and
using said activity duration information for payroll calculation.

7. The method according to claim 2, which includes the additional steps of:
temporarily storing said duration information on a respective computer terminal computer in the event of network inavailability; and
automatically transferring said duration information to said server upon said network becoming available.

8. The method according to claim 1, which includes the additional steps of:
providing a user-adjustable MID; and
said user adjusting said MID.

9. An automated time keeping method, which includes the steps of:
providing a computer network including multiple, individual computer terminals each including a monitor;
providing said network with an administrator function and a server associated therewith for accessing said terminals;
preprogramming said terminals with a log in function;
displaying a screensaver with a log in area on said terminal monitors;
logging in to said terminals with unique user identifiers and/or passwords each associated with a respective terminal and/or user;
setting a predetermined maximum inactivity duration (MID) with said administrator function;
monitoring the inactivity duration of said terminals while logged in;
comparing the duration of inactivity for each terminal to said MID;
automatically logging off the user associated with a terminal in the event the inactivity duration thereat exceeds said MID;
computing for each said terminal a net activity duration representing the time between a respective user logging in and logging off;
computing an adjusted activity duration for each said user automatically logged off by subtracting said MID from a respective net activity duration;
providing a database connected to said network;
storing said adjusted activity duration information in said database;
retrieving said stored adjusted activity duration information from said database; and
utilizing said adjusted activity duration information for a purpose associated with said time keeping function.

10. The method according to claim 9, which includes the additional steps of:
temporarily storing said activity duration information on a respective said computer in the event of network inavailability; and
automatically transferring said activity duration information to said server upon availability of said network.

11. The method according to claim 9, which includes the additional steps of:
displaying a screensaver with a log in area on each said computer monitor;
a user logging in to a respective computer terminal;
closing said the screensaver upon said user logging in to said computer terminal;
commencing said activity duration upon said login; and
redisplaying said screensaver upon said MID being exceeded.

12. The method according to claim 9, which includes the additional steps of:
providing access to said network from multiple, remote locations via the world wide web (Internet).

13. The method according to claim 9, which includes the additional steps of:
providing a log off screen including a log off area;
displaying said log off screen; and
a user logging off of a respective computer terminal using said log off area.

14. The method according to claim 13, which includes the additional steps of:
providing a function whereby a user can close a first application, open a second application and record activity durations for activities associated with each said application; and
providing a function whereby a user can optionally display said log off screen and/or said screensaver upon terminating an activity.

15. The method according to claim 9, which includes the additional steps of:
allocating human resources according to adjusted activity duration information stored in said database.

16. The method according to claim 9, which includes the additional steps of:
saving respective adjusted activity duration information for multiple said computer users;
generating a payroll report for each said user from said adjusted activity duration information; and
transmitting said payroll report.

17. The method according to claim 16, which includes the additional steps of:
generating payroll information for each said user including his or her respective withholdings and taxes from said adjusted activity duration information; and
compiling and reporting payroll information from multiple said reports for an organization.

18. The method according to claim 9, which includes the additional steps of:
providing a central display at said server and/or accessible to an administrator; and
displaying on said central display user identification, time arrived, time in, time out and notes information.

19. The method according to claim 9, which includes the additional steps of:
providing an individual user display on each said monitor; and
displaying on said user displays information corresponding to time in, time out, activity duration and notes.

20. A time keeping system for multiple users, which includes:
a network including multiple, individual computer terminals with monitors;
a server accessible by a network administrator;
a screensaver including a login area adapted for being displayed on each said monitor;
a user log in function associated with each said computer terminal and a respective login area;
a user password function associated with each said user;
a preprogrammed maximum inactivity duration (MID) associated with each said computer;
a net activity duration function preprogrammed on said network for application to each said computer and adapted for computing a net activity duration corresponding to the time difference between an activity commencement and an activity termination;
an automatic log off function adapted to automatically log a user off of a respective said terminal in the event said MID is succeeded;
a database connected to said network and adapted for storing information corresponding to adjusted time durations recorded on each said terminal;
a voluntary log off function including a log off screen display with a log off area;
said MID comprising a user-adjustable variable; and
each said terminal being adapted to be preprogrammed with multiple said MIDs each corresponding to a respective task and/or application of said computer terminal.
